(19) United States
(12) Patent Application Publication
(10) Pub. No.: US 2015/0350464 A1
(43) Pub. Date: Dec. 3, 2015

(54) IMAGE FORMING APPARATUS CAPABLE OF RECEIVING FAX DATA, FAX DATA TRANSFERRING METHOD AND STORAGE MEDIUM

(71) Applicants: Kabushiki Kaisha Toshiba, Tokyo (JP); Toshiba Tec Kabushiki Kaisha, Tokyo (JP)

(72) Inventor: Satoshi Tokuda, Mishima-shi (JP)

(73) Assignees: Kabushiki Kaisha Toshiba, Tokyo (JP); Toshiba Tec Kabushiki Kaisha, Tokyo (JP)

(21) Appl. No.: 14/288,579

(22) Filed: May 28, 2014

(51) Int. Cl. H04N 1/00

(52) U.S. Cl. CPC H04N 1/00212; H04N 2201/0093

(57) ABSTRACT

An image forming apparatus comprises an interface and a control section. The interface receives the FAX data obtained from a public line network. The control section converts the FAX data into an image in a computer-displayable form, stores the converted image in a storage section, creates first information in which the storage position of the image is designated and transmits the first information to a computer in an Email form.

### FIELD

Embodiments described herein relate to an image forming apparatus capable of receiving FAX data.

### BACKGROUND

A function is currently available with which when a FAX or an iFAX (Internet FAX) is received by an image forming apparatus, a received image can be added as an Email attachment and then transmitted to a user. This function of transferring a FAX or an iFAX image based on the transmission of an Email is called a receiving transferring function, which has the following problems:

Problem 1: the addition of a great number of FAX/iFAX images in an Email and the transmitting of the Email containing the FAX/iFAX images is a load to a relay server and an increase in the storage volume of the mail box of a mail server.

Problem 2: to transmit the Email to each address, addresses are increased, which increases the load of the server.

Problem 3: When receiving the FAX/iFAX data, the FAX/iFAX data is definitely transferred to preset addresses, which forces the recipients to receive unnecessary FAX/iFAX images. Consequentially, the storage of the received unnecessary images in a client PC (Personal Computer) increases the storage volume of the client PC.

Problem 4: after receiving the Email in the client PC, to share the images with others, the images must be transferred to a file server or a transfer destination, which is troublesome.

### DESCRIPTION OF THE DRAWINGS

FIG. 1 is a diagram exemplifying the configuration of a system according to embodiments described herein;

FIG. 2 is a diagram exemplifying the configuration of an image forming apparatus;

FIG. 3 is a flowchart exemplifying the operations of an image forming apparatus;

FIG. 4 is a diagram exemplifying the body of an Email in which a URL is recorded;

FIG. 5 is a flowchart exemplifying a file deletion operation;

FIG. 6 is a diagram exemplifying a correspondence table of telephone numbers and Email addresses of the transmission destination;

FIG. 7 is a diagram exemplifying a correspondence table of Email addresses of the transmission destination and conversion forms;

FIG. 8 is a diagram exemplifying a correspondence table of Email addresses of the transmission destination and storage periods; and

FIG. 9 is a diagram exemplifying the configuration of a server to which, instead of to an image forming apparatus, the embodiments described herein are applied.

### DETAILED DESCRIPTION

In accordance with an embodiment, an image forming apparatus comprises an interface and a control section. The interface receives the FAX data obtained from a public line network. The control section converts the FAX data into an image in a computer-displayable form, stores the converted image in a storage section, creates first information in which the storage position of the image is designated and transmits the first information to a computer in an Email form.

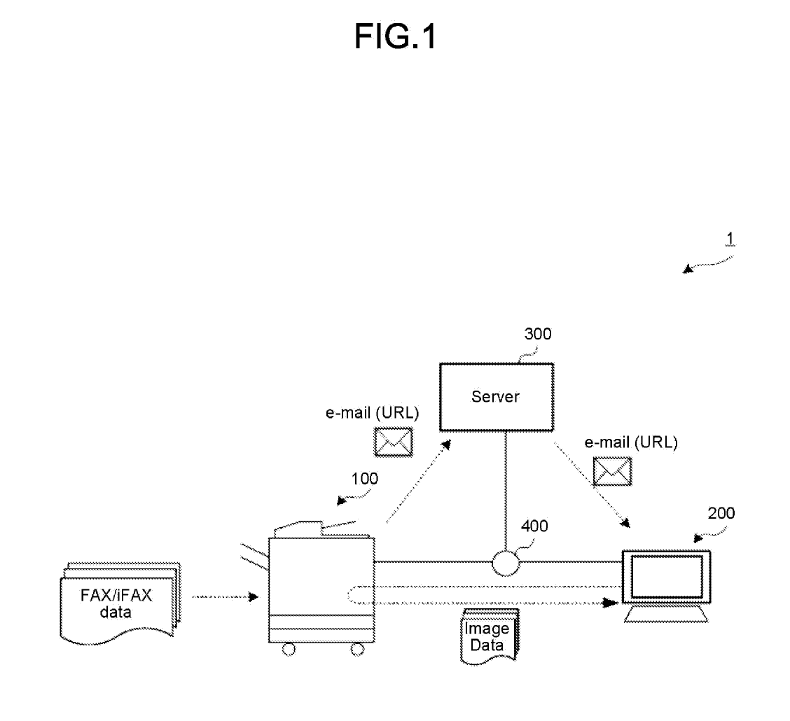

The image forming apparatus is described below with reference to the accompanying drawings. FIG. 1 is a diagram exemplifying the configuration of a system according to embodiments described herein, in which the data flow is represented by a dashed line. A system 1 comprises an image forming apparatus 100, a client PC 200 and a server 300 among which data transmission/reception can be carried out via a network 400.

The image forming apparatus 100 is an image forming apparatus having a function of receiving the FAX/iFAX obtained from a public line network. The client PC 200 is a computer daily used by the user in which a mail receiving application and a WEB browser are imported in advance. The server 300 is a mail server in which the mailbox of the user who uses the client PC 200 is registered in advance.

Here, the summary of embodiments of the present invention is described below with reference to FIG. 1. When receiving a FAX or an iFAX from a public line network, the image forming apparatus 100 records the link destination URL (Uniform Resource Locator) of the image data obtained from the FAX/iFAX in the body of an Email and transmit the Email. The client PC 200 obtains the image of the FAX/iFAX by receiving the Email and opening the link destination URL.

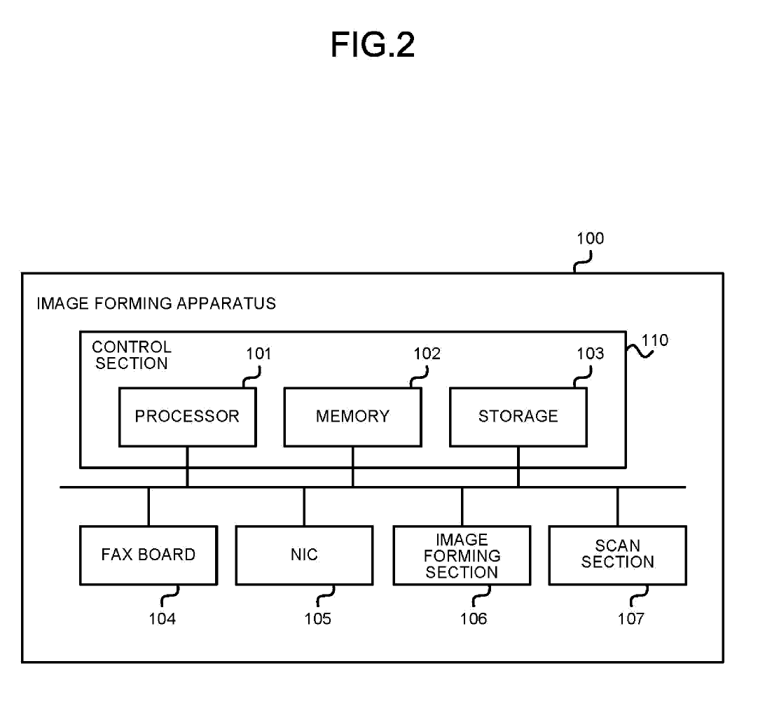

Next, the internal configuration of the image forming apparatus 100 is described with reference to FIG. 2. The image forming apparatus 100 may comprise a processor 101, a memory 102, a storage 103, a FAX board 104, a NIC (network card) 105, an image forming section 106 and a scanning section 107. The image forming apparatus 100 may comprise a processor 101, a memory 102 and a storage 103, thereby functioning as a control section 110.

The processor 101, which is, for example, a CPU (Central Processing Unit), executes the program pre-stored in the storage 103. In this way, the processor 101 controls each device inside the image forming apparatus 100. The memory 102 is a volatile main storage device. The storage 103 is, for example, a hard disk drive which functions as an auxiliary nonvolatile storage device. A specified program for realizing embodiments of the present invention, a WEB server program, the layout data for the display on a WEB and the like are stored in the storage 103 in advance.

The FAX board 104 is a board for receiving or transmitting a FAX via a public line network, and the NIC 105 is, for example, a board in accordance with the IEEE 802.3 standard. Through the NIC 105, the image forming apparatus 100 carries out data transfer between the server 300 and the client PC 200. Further, the data of an iFAX on an LAN or the Internet is subjected to a signal conversion and then received in the NIC 105.

The image forming section 106 forms the image read by a scanning section 107 and the printing data transmitted from an external device (e.g. client PC 200) on a sheet. The image forming section 106 comprises a processing unit for transferring a toner image on a sheet, a fixing device for fixing the transferred toner image on the sheet and the like. The scanning section 107, which is a unit for reading an original sheet by scanning it, comprises an optical system including a light-emitting element, a mirror and lens and an image capturing element.

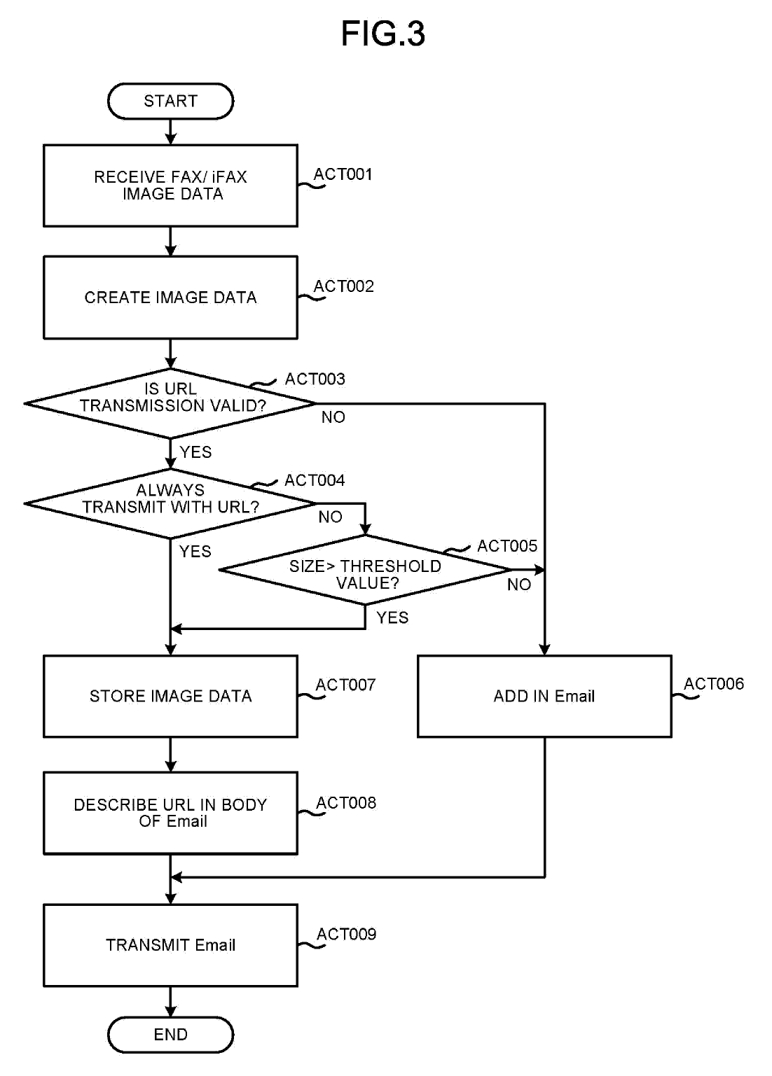

FIG. 3 is a flowchart exemplifying the operations of the image forming apparatus 100. The operations shown in FIG. 3 are carried out through the cooperation of the program stored in the storage 103 which is developed in the memory 102 and executed by the processor 101 with the hardware in the image forming apparatus 100. Further, the following items may be set in the receiving transferring function of the embodiment using the manager authority:
the validity/invalidity of a URL transmission function; always transmit with URL?;

Threshold value of size of file transmitted with URL (threshold value (e.g. from 1 Mbyte-100 Mbyte) for limiting the transmitting of large volume data);

Form (PDF/TIFF/XPS and the like) of converted image.

The aforementioned set values can be stored in the storage 103 permanently and changed through the maintenance job of the manager.

The processor 101 receives FAX/iFAX image data (ACT 001). This operation is carried out by the FAX board 104 by receiving an FAX image through a public telephone line or by the NIC by receiving an iFAX image through an LAN (Local Area Network). The processor 101 temporarily stores the acquired FAX/iFAX image data in the memory 102.

The processor 101 converts the received FAX/iFAX data into any one of file formats (PDF, TIFF and XPS) according to the setting of the manager (ACT 002). The file format can be any format as long as it is displayable by the client PC 200. The created image file is stored in the memory 102 in this stage.

The image conversion is described below. If the image data is FAX image data, then the data coded using MMR format is decoded and converted into an image format designated by the user. Further, if the image data is iFAX data, one-dimensional coded data (MH) is extracted from attachment data among Header/Body/Attachment and then converted into a user-designated format.

The processor 101 determines whether or not the URL transmission is valid by reading a flag value stored in the storage 103 (ACT 003). If the URL transmission is invalid (No in ACT 003), the processor 101 converts the image into an MIME format by controlling the NIC 105, adds the converted image in an Email (ACT 006) and transmits the image in an Email form (ACT 009).

If the URL transmission is valid (Yes in ACT 003), whether or not to always transmit with an URL is determined by reading the flag value stored in the storage 103 (ACT 004). If the setting is ‘not always transmit with URL’ (No in ACT 004), the processor 101 acquires the threshold value stored in the storage 103 and compares the threshold value with the size of the image file created in ACT 002 (ACT 005). If the size of the image file is smaller than the threshold value (No in ACT 005), the processor 101 adds the image in an Email (ACT 006) and then transmits the Email (ACT 009).

If the setting is ‘always transmit with URL’ in ACT 004 (Yes in ACT 004) or the size of the image file is greater than the threshold value in ACT 005 (Yes in ACT 005), the processor 101 stores the image data created in ACT 002 in the storage 103 (ACT 007). The area in which the image data is stored is an area which can be accessed from the outside of the image forming apparatus 100, further, when storing the image data, the processor 101 generates a character string through an encryption processing, generates a folder named the character string, endows the folder with a file name imported in a given way and stores the image data.

The processor 101 describes the text information representing the URL link destination of the created file in the body of the Email (ACT 008). An example of the described URL is described below. The character string (folder name) encrypted in this way is inserted into the URL path so that people who does not know the URL cannot access the file.

After ACT 008 is carried out, the processor 101 transmits the Email to the server 300 via the NIC 105 (ACT 009). Besides, we can transmit an Email to the email address of one user or more than one email address or CC/BCC the mail.

The user operates the client PC 200 to receive the Email from the server 300. When the image is added in the Email, the user opens the image to confirm the image. Further, if the URL is recorded in the body of the Email, the WEB browser of the client PC 200 is started by selecting the URL to display the image, and the image can be downloaded and stored in the client PC 200, if needed. In this case, the processor 101 of the image forming apparatus 100 starts a WEB server program to respond to the access from the client PC 200.

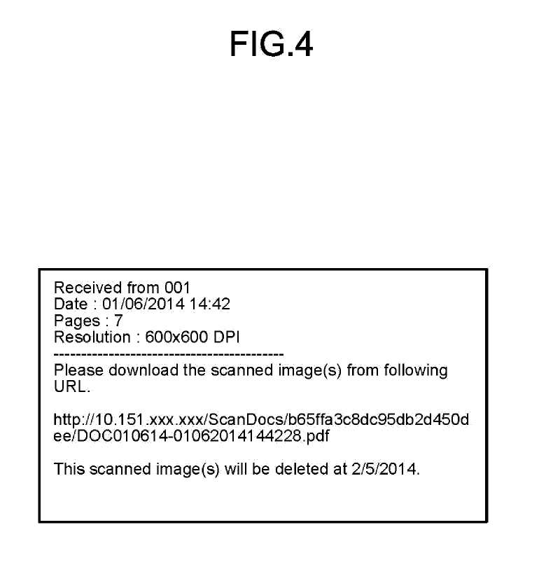

An example in which an URL is recorded in the body of an Email is shown in FIG. 4. As shown in FIG. 4, the telephone number (‘001’ in the initial row) of the transmitting source, a receiving date and time, a page number (pages) and a resolution may be added in the body of the Email.

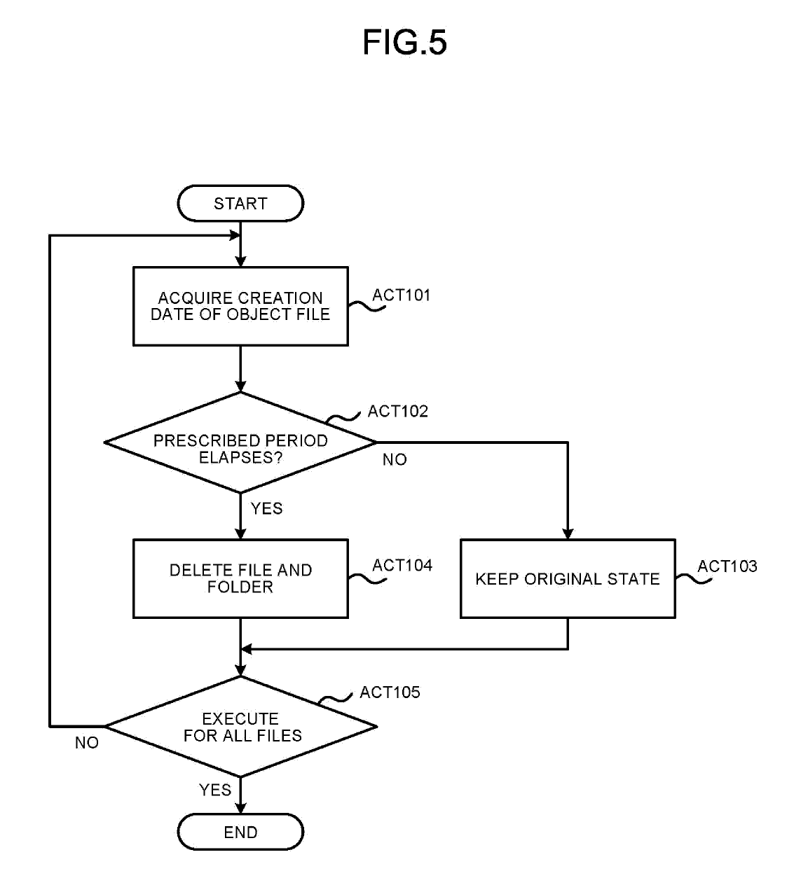

Further, a deletion date may be set, as shown in the last row shown in FIG. 4. The deletion date is set to guarantee the storage capacity of the storage 103 of the image forming apparatus 100. The image forming apparatus 100 carries out a job management by executing the operations shown in the flowchart of FIG. 5 at a given time (e.g. 0:00). The operations are described below. When a given time is reached, the processor 101 determines whether or not a predefined period (1-99 days) elapses (ACT 102) by reference to the creation date of the image file (ACT 101). The processor 101 keeps the file in the original state if the prescribed period does not elapse (No in ACT 102, and then proceeds to ACT 103) and deletes each file if the prescribed period elapsed (Yes in ACT 102, and then proceeds to ACT 104). The processor 101 carries out the processing for each image file (Loop of No in ACT 105). Besides, the operations can be carried out asynchronously with the operations shown in FIG. 3.

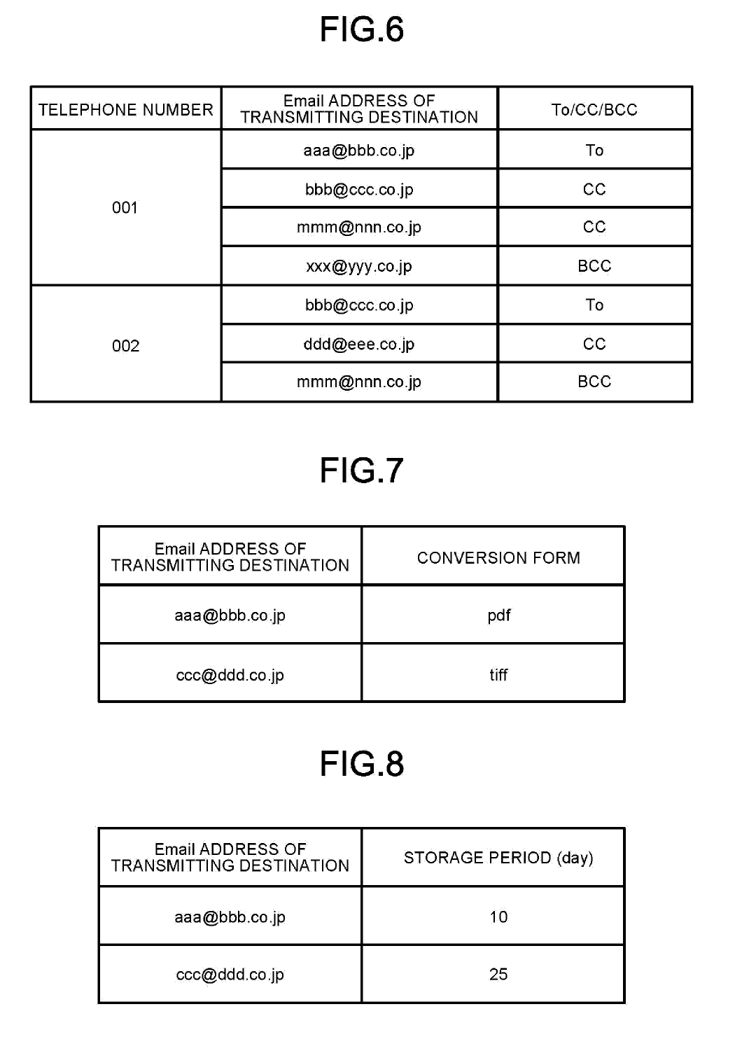

Further, as to the transmitting of ACT 009 shown in FIG. 3, the address may be set by assigning an Email address to each FAX telephone number of the transmitting source (in the case of iFAX, each address of the transmitting source). In this case, for example, in the receiving of a FAX, it is possible that an image received from a telephone number 001 is transferred to ‘aaa@bbb.co.jp’, and an image received from the telephone number 002 is transmitted to ‘ccc@ddd.co.jp’. This is achieved by storing the table shown in FIG. 6 in which telephone numbers and Email addresses of transmitting destination are associated in the storage 103. When transmitting an Email, the processor 101 checks the telephone number of the transmitting source and retrieves the telephone number of the transmitting source in the correspondence table shown in FIG. 6 to acquire the Email address of the transmitting destination. Further, as shown in FIG. 6, in addition to the address (To), CC and Bcc are also registered in the correspondence table, if needed, so that the Email can be transmitted to a plurality of recipients. Further, a plurality of recipients (To) may be set.

Further, in the example above, an example of the conversion into an image in any of PDF/TIFF/XPS form is described, however, if the image data is set to be converted into an TIFF image, then the image cannot be confirmed in a PC incapable of processing a TIFF image. Thus, the image can be converted according to the Email address of the transmitting destination. In this case, as shown in FIG. 7, a table in which Email addresses of the transmitting destination are correlated with conversion forms is stored in the storage 103 to realize the above conversion. The processor 101 reads the table shown in FIG. 7 in ACT 002, converts the image into a PDF image if the transmitting destination is, for example, ‘aaa@bbb.co.jp’ or a TIFF image if the transmitting destination is ccc@ddd.co.jp′.

Further, the data storage period may be changed according to the Email address of the transmitting destination. As shown in FIG. 8, a table in which addresses of the transmitting destination are associated with data storage period is stored in the storage 103 in advance. Further, in the Email transmitting of ACT 009, the processor 101 retrieves the table in FIG. 8 using the Email addresses of the transmitting destination to acquire the hit data storage period. The processor 101 calculates a data deletion date by adding the data storage period to the current date and stores the calculated date in the generated encrypted folder. In performing the deletion job shown in FIG. 5, the processor 101 determines whether or not to carry out a deletion operation by confirming the deletion date information for each folder.

Further, the aforementioned modes can be combined by associating the tables shown in FIG. 6-FIG. 8.

Further, that the client PC 200 accesses to the image forming apparatus 100 provided with a WEB server function is described in embodiments described herein, however, the WEB server function may also be set in another server, for example, in the server 300. In this case, the processor 101 of the image forming apparatus 100 transmits the converted image data to the server 300 in ACT 007. At this time, the processor 101 synchronously transmits the information of the folder name and the file name of the storage destination. The server 300 stores the image data according to the received information. Further, the URL of the server 300 is designated in ACT 008. In this mode, from the point of view of load distribution, a plurality of server housings (WEB servers) may be arranged. The processor 101 may transmit image data to the servers in a round robin manner in sequence, or the server of the transmitting destination may be determined according to the capacity of the storage section of each server. In the case of a plurality of servers, the URL recorded in the body of an Email apparently becomes the URL of each server.

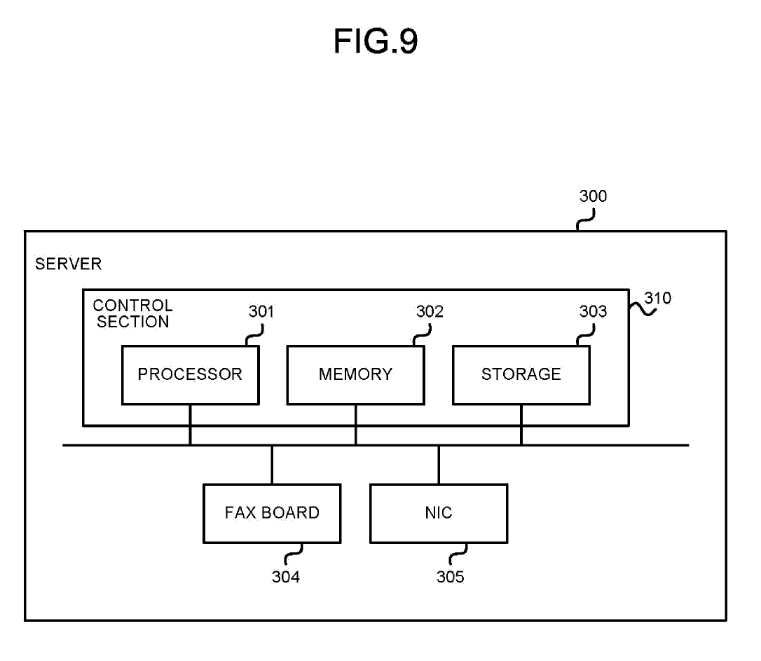

Further, in the description above, an embodiment is described according to which the image forming apparatus 100 receives FAX data, converts the received FAX data to an image form displayable by a computer, stores the converted image in the storage section and transmits the URL to the client PC 200 in an Email form. However, the present invention is not limited to this, and the operations carried out by the image forming apparatus 100 may be carried out by the server 300. In this case, the server 300 has the structure shown in FIG. 9. The server 300 (computer) may comprise a processor 301, a memory 302, a storage 303, a FAX board 304 and a NIC 305, wherein the server 300 comprises the processor 301, the memory 302 and the storage 303 to function as the control section 310. Each of the aforementioned units is the same as that of the image forming apparatus 100 shown in FIG. 2 and is therefore not described here.

Apart from the FAX data transmitted via a public telephone network, the FAX data also includes the iFAX data obtained through a wide area network. Further, the first information is equivalent to the URL described in embodiments described herein.

With this structure, the aforementioned problems can be addressed.

As to problem 1, as the transmitting of an image in an Email form is prevented, the load of the server can be relieved.

As to problem 2, as the content to be transmitted is an Email merely containing an URL with parts of forms being omitted, no great load is applied to the server even if addresses are increased.

As to problem 3, the user may don't download unnecessary images according to the address. Further, the user may also just browse in the WEB browser.

As to problem 4, as a plurality of Email transmitting destinations can be preset aiming at each receiving source, the image can be shared easily among a plurality of users (the possibility that transferring the received Email again becomes low). Further, in the case where an URL is recorded in the body of an Email, the received Email can be transferred again merely by sharing the URL.

In each embodiment described above, the functions for realizing each mode are prerecorded in the apparatus, however, the present invention is not limited to this, the same functions may also be downloaded to the apparatus from a network or stored in a recording medium and then installed in the apparatus. The recording medium may be any recording medium (e.g. CD-ROM) that is capable of storing programs and readable to the apparatus. Further, the functions achieved through an installing or downloading can also be achieved through the cooperation with an OS (Operating System) in the apparatus.

According to embodiments described herein, the traffic load of Email transmitting and the load of the server resource can be reduced when FAX data is received.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
an interface configured to receive the FAX data obtained through a public line network;
a control section configured to convert the FAX data into an image in a computer-displayable form, store the converted image in a storage section, create first information in which the storage position of the image is designated and transmit the first information to a computer in an Email form; and
a correspondence table which registers in association with the telephone number and one or more destination address; wherein
when receiving the fax data from a telephone number which is registered in the correspondence table associating the telephone number and one or more mail address, the control section transmits the first information to the corresponding one or more mail address.

2. The image forming apparatus according to claim 1, wherein
the control section determines the transmitting destination of the Email according to the identification information of a transmitting source, acquires image form information from a table in which the transmitting destination of an Email and image form information are associated according to the determined transmitting destination of the Email and converts the FAX data into an image in the form indicated by obtained image form information.

3. The image forming apparatus according to claim 1, wherein
the control section deletes an image from the storage section after a prescribed period elapses.

4. The image forming apparatus according to claim 3, wherein
the control section determines the transmitting destination of the Email according to the identification information of the transmitting source, acquires prescribed period information from a table in which the transmitting destination of the Email and prescribed period information are associated according to the determined transmitting destination of the Email and determines whether or not to delete an image from the storage section based on the prescribed period information.

5. The image forming apparatus according to claim 1, wherein
the control section attaches the image to the Email if the size of the converted image is smaller than a predefined threshold value and transmits the Email to the computer.

6. The image forming apparatus according to claim 1, wherein
the control section transmits the first information to a designated user in an Email form if the value of preset flag data is a value indicating a transmission using the first information, or attaches the image to the Email and then transmits the Email to the designated user if the value of preset flag data is not a value indicating the transmission using the first information.

7. A FAX data transferring method of an image forming apparatus, the method comprising the steps of:
receiving the FAX data obtained from a public line network using the image forming apparatus;
converting the FAX data into an image in an form displayable by a computer;
storing the converted image in a storage section;
creating first information in which the storage position of the image is designated;
transmitting the first information to the computer in an Email form, and
when receiving the fax data from a telephone number which is registered in a correspondence table associating the telephone number and one or more mail address, transmitting the first information to the corresponding one or more mail address, wherein the correspondence table registers in association with the telephone number and one or more destination address.

8. The FAX data transferring method according to claim 7, wherein
the image forming apparatus further determines the transmitting destination of the Email according to the identification information of a transmitting source;
acquiring image form information from a table in which the transmitting destination of an Email is associated with image form information according to the determined transmitting destination of the Email; and
converting the Fax data into an image in a form indicated by the obtained image form information.

9. The FAX data transferring method according to claim 7, wherein
deleting an image from the storage section after a prescribed period elapses.

10. The FAX data transferring method according to claim 9, wherein
determining the transmitting destination of the Email according to the identification information of the transmitting source;
acquiring prescribed period information from a table in which the transmitting destination of the Email and prescribed period information are associated according to the determined transmitting destination of the Email; and
determining whether or not to delete an image from the storage section based on the prescribed period information.

11. The FAX data transferring method according to claim 7, wherein
attaching the image to the Email if the size of the converted image is smaller than a predefined threshold value and transmits the Email to the computer.

12. The FAX data transferring method according to claim 7, wherein
transmitting the first information to a designated user in an Email form if the value of preset flag data is a value indicating a transmission using the first information, or attaching the image to the Email and then transmits the Email to the designated user if the value of preset flag data is not a value indicating the transmission using the first information.

13. A non-transitory computer readable medium storing instructions causing an image forming apparatus, to perform the steps of:
receiving the FAX data obtained from a public line network;
converting the FAX data into an image in a computer-displayable form;
storing the converted image in a storage section;
creating first information in which the storage position of the image is designated;
transmitting the first information to the computer in an Email form; and
when receiving the fax data from a telephone number which is registered in a correspondence table associating the telephone number and one or more mail address, transmitting the first information to the corresponding one or more mail address, wherein the correspondence table registers in association with the telephone number and one or more destination address.

14. The non-transitory computer readable medium according to claim 13, wherein
determining the transmitting destination of the Email according to the identification information of a transmitting source;
acquiring image form information from a table in which the transmitting destination of an Email is associated with image form information according to the determined transmitting destination of the Email; and
converting the FAX data into an image in a form indicated by the obtained image form information.

15. The non-transitory computer readable medium according to claim 13, wherein
deleting an image from the storage section after a prescribed period elapses.

16. The non-transitory computer readable medium according to claim 15, wherein
determining the transmitting destination of the Email according to the identification information of the transmitting source;
acquiring prescribed period information from a table in which the transmitting destination of the Email and prescribed period information are associated according to the determined transmitting destination of the Email; and
determining whether or not to delete an image from the storage section based on the prescribed period information.

17. The non-transitory computer readable medium according to claim 13, wherein
attaching the image to the Email if the size of the converted image is smaller than a predefined threshold value and transmits the Email to the computer.

18. The non-transitory computer readable medium according to claim 13, wherein
transmitting the first information to a designated user in an Email form if the value of preset flag data is a value indicating a transmission using the first information, or attaching the image to the Email and then transmits the Email to the designated user if the value of preset flag data is not a value indicating the transmission using the first information.

19. The image forming apparatus according to claim 1, wherein when transmitting the Email, the control section checks the telephone number of the transmitting source and retrieves the telephone number of the transmitting source in the correspondence table to acquire the one or more mail address of the transmitting destination, and transmits the first information to the acquired one or more mail address.

20. The image forming apparatus according to claim 1, wherein the correspondence table further has a field which registers one of the To, CC or BCC for each destination mail address.
